(19) United States
(12) Patent Application Publication
(10) Pub. No.: US 2026/0079791 A1
(43) Pub. Date: Mar. 19, 2026

(54) MEMORY SYSTEM AND INFORMATION PROCESSING SYSTEM

(71) Applicant: Kioxia Corporation, Tokyo (JP)

(72) Inventor: Shinobu SUGIURA, Tokyo (JP)

(73) Assignee: Kioxia Corporation, Tokyo (JP)

(21) Appl. No.: 19/080,135

(22) Filed: Mar. 14, 2025

(30) Foreign Application Priority Data
Sep. 18, 2024 (JP) 2024-161482

(51) Int. Cl. G06F 11/10; G06F 11/16

(52) U.S. Cl. CPC G06F 11/1068; G06F 11/1016; G06F 11/167

(57) ABSTRACT

There are provided a memory system and an information processing system in which measures against transient errors are implemented. In one example, a memory system includes: a nonvolatile memory chip; and a controller that controls the nonvolatile memory chip. The nonvolatile memory chip has a first storage unit that stores address translation information for translating a logical address into a physical address and management information for the controller managing the nonvolatile memory chip, and a second storage unit that stores, for every first cycle, duplicate information of the address translation information and the management information stored in the first storage unit, and the controller controls whether or not to cause the duplicate information stored in the second storage unit to be exhibited in the first storage unit.

### CROSS-REFERENCE TO RELATED APPLICATION

This application is based upon and claims the benefit of priority from Japanese Patent Application No. 2024-161482, filed Sep. 18, 2024, the entire contents of which are incorporated herein by reference.

### FIELD

Embodiments described herein relate generally to a memory system and an information processing system.

### BACKGROUND

Artificial satellites orbit in different orbit zones depending on their purposes of use. For example, the low orbit zone of 300 km to 2000 km from the ground is often used for artificial satellites for civilian use. Since the low orbit zone has a lesser amount of radiation of cosmic rays than at the high orbit zone, it is being investigated to use general-purpose electronic components similar to those on the ground for electronic devices used in the low orbit zone.

### BRIEF DESCRIPTION OF DRAWINGS

FIG. 1 is a block diagram showing a schematic configuration of an information processing system including a memory system according to an embodiment.

FIG. 2 is a flowchart showing processing operation of the memory system according to the present embodiment.

FIG. 3 is a flowchart showing processing operation of a memory system according to a first modification of the present embodiment.

FIG. 4 is a flowchart showing processing operation of an information processing system according to a second modification of the present embodiment.

FIG. 5 is a flowchart showing processing operation of an information processing system according to a third modification of the present embodiment.

### DETAILED DESCRIPTION

Therefore, an embodiment of the present invention provides a memory system and an information processing system in which measures against transient errors are implemented.

In general, according to one embodiment, in order to solve the aforementioned problem, as well as other problems, there is provided a memory system including:
a nonvolatile memory chip; and
a controller that controls the nonvolatile memory chip, wherein
the controller
stores, in a first storage unit of the nonvolatile memory chip, address translation information for translating a logical address into a physical address and management information for the controller managing the nonvolatile memory chip,
for every first cycle, stores, in a second storage unit of the nonvolatile memory chip, duplicate information of the address translation information and the management information stored in the first storage unit, and
determines whether or not to cause the duplicate information stored in the second storage unit to be exhibited in the first storage unit.

Hereafter, embodiments of a memory system and an information processing system will be described with reference to the drawings. While primary configurational portions of the memory system and the information processing system are hereafter mainly described, there can be, in those systems, configurational portions and functions that are not illustrated or described. The description below does not eliminate such configurational portions or functions that are not illustrated or described.

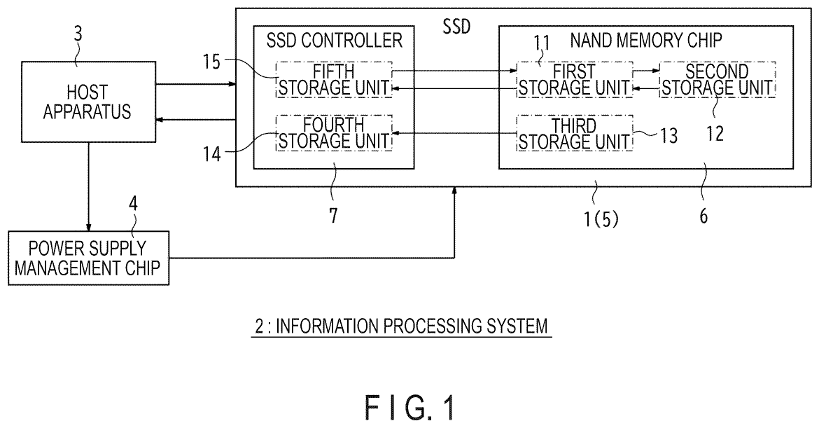

FIG. 1 is a block diagram showing a schematic configuration of an information processing system 2 including a memory system 1 according to an embodiment. The memory system 1 and the information processing system 2 according to the present embodiment are supposed to be used for not only various electronic devices used on the ground but also various electronic devices mounted on artificial satellites positioned in a low orbit zone at altitudes of 300 km to 2000 km from the ground. Since the low orbit zone has a greater amount of radiation of radioactive rays such as cosmic rays than the ground, the memory system 1 and the information processing system 2 according to the present embodiment take measures against destructive performance effects on the electronics due to the radioactive rays.

The information processing system 2 according to an embodiment shown in FIG. 1 includes the memory system 1, a host apparatus 3, and a power supply management chip 4. For example, the memory system 1 according to the present embodiment is an SSD (Solid State Drive) 5 using a NAND flash memory (hereafter called a NAND memory). Otherwise, the memory system 1 according to the present embodiment can also be applied to memory systems composed of a memory chip and a memory controller having controller circuitry (programmable or fixed-function circuitry), for example, such as an AFA (All Flash Array), a UFS (Universal Flash Storage) device, an MMC (Multimedia Card), an SD™ card, and a USB (Universal Serial Bus) memory. Moreover, the memory system 1 according to the present embodiment can also be applied to systems using a nonvolatile memory, other than the NAND memory, (for example, an MRAM: Magnetoresistive Random Access Memory, a ReRAM: Resistive Random Access Memory, a PRAM: Phase-change Random Access Memory, or the like) and a memory controller, like that discussed above. There is hereafter mainly described an example in which the memory system 1 according to an embodiment is the SSD 5 using the NAND memory.

As shown in FIG. 1, the SSD 5 has a NAND memory chip 6 and an SSD controller 7. The NAND memory chip 6 has a plurality of NAND memories. In more detail, the NAND memory chip 6 has a first storage unit 11 and a second storage unit 12. Each of the first storage unit 11 and the second storage unit 12 include a NAND memory. Alternatively, a single compartmentalized NAND memory may be used as opposed to separate NAND memories.

The SSD controller 7 stores, in the first storage unit 11, address translation information for translating a logical address into a physical address, and management information for the SSD controller 7 managing the NAND memory chip 6. The SSD controller 7 updates the address translation information and the management information stored in the first storage unit 11 in arbitrary timing.

The SSD controller 7 stores, in the second storage unit 12, duplicate information of the address translation information and the management information stored in the first storage unit 11, for every first cycle. Moreover, the duplicate information may be stored in the second storage unit 12 every time when information in the first storage unit 11 is updated. Furthermore, together with the address translation information and the management information, the second storage unit 12 may store a duplicate of user data stored in the NAND memory chip 6. For example, the user data includes at least one of a program of an operation system (code that is executable by one or more processors), a program of application software operated on the operation system (other executable code), data used for the operation system, and data used for the application software.

The NAND memory chip 6 has a third storage unit 13 that stores firmware. As mentioned later, in start-up of the SSD 5, the SSD controller 7 reads and executes the firmware stored in the third storage unit 13. The firmware is a program (executable code) that upon execution a CPU in the SSD controller 7 configures the CPU to control the SSD 5.

By executing the firmware, the SSD controller 7 controls the NAND memory chip 6, and communicates with the host apparatus 3. Specifically, the SSD controller 7 performs control of updating the address translation information and the management information stored in the first storage unit 11 in arbitrary timing, and storing, in the second storage unit 12, the duplicate information of the address translation information and the management information stored in the first storage unit 11 for every first cycle.

Moreover, the SSD controller 7 determines whether or not to cause the duplicate information stored in the second storage unit 12 to be exhibited in the first storage unit 11. When it is determined that a transient error caused by radioactive rays such as cosmic rays occurs, the SSD controller 7 causes the duplicate information stored in the second storage unit 12 to be exhibited in the first storage unit 11. For example, the SSD controller 7 determines whether or not the transient error caused by radioactive rays occurs, at a time length not less than a second cycle shorter than the first cycle at which the second storage unit 12 stores the duplicate information of the first storage unit 11. Moreover, the SSD controller 7 may determine whether or not the transient error caused by radioactive rays occurs, based on communication with the host apparatus 3. By the duplicate information stored in the second storage unit 12 being caused to be exhibited in the first storage unit 11, the address translation information and the management information in the first storage unit 11 used by the SSD controller 7 are updated into the duplicate information stored in the second storage unit 12. Hereafter, the SSD controller 7 is occasionally called controller or memory controller.

The host apparatus 3 makes an access request to the SSD 5. To the SSD 5, the host apparatus 3 issues various commands indicating types of the access request. The host apparatus 3 can issue various commands such as write of data to the SSD 5, read of data from the SSD 5, and erase of data in the SSD 5. Moreover, by transmitting a signal using a special command or communication line to the SSD controller 7, the host apparatus 3 may be able to request to cause the duplicate information stored in the second storage unit 12 to be exhibited in the first storage unit 11.

The SSD 5 and the host apparatus 3 perform high-speed serial transmission, for example, in conformity to the communication standards of PCI (Peripheral Component Interconnect) Express. Notably, the communication standards between the SSD 5 and the host apparatus 3 are optional, and communication standards other than the PCI Express may be employed.

The SSD controller 7 has a plurality of storage units (e.g., semiconductor memory circuitry, as will be discussed). These plurality of storage units may be built in the SSD controller 7, or may be connected to the SSD controller 7. There is hereafter described an example in which the plurality of storage units have a fourth storage unit 14 and a fifth storage unit 15 and these fourth storage unit 14 and fifth storage unit 15 are built in the SSD controller 7.

The fourth storage unit 14 stores firmware that controls the SSD controller 7. When a power supply of the SSD 5 is turned on or is reset, the SSD controller 7 saves the firmware that is stored in the third storage unit 13 of the NAND memory chip 6 in the fourth storage unit 14. After that, the SSD controller 7 reads and executes the firmware that is stored in the fourth storage unit 14.

The fifth storage unit 15 stores address translation information for translating a logical address issued by the host apparatus 3 into a physical address of the NAND memory chip 6, and management information for the controller managing the NAND memory chip 6. For example, the address translation information includes a lookup table (LUT). The lookup table is an address translation table for the logical address and the physical address. The management information includes number-of-times information of write/erase of the NAND memories, and bad block information including address information of broken blocks.

After the power supply of the SSD 5 is turned on, the SSD controller 7 refers to the address translation information and the management information stored in the fifth storage unit 15, when executing the firmware. Moreover, the SSD controller 7 updates at least one of the address translation information and the management information stored in the fifth storage unit 15, as needed. When updating the at least one of the address translation information and the management information, the SSD controller 7 causes the address translation information and the management information after the update to be exhibited in the first storage unit 11 of the NAND memory chip 6. As mentioned later, the first storage unit 11 may store a plurality of sets of the address translation information and the management information on a generation-by-generation basis. In this case, the SSD controller 7 stores the updated set of the address translation information and the management information in the first storage unit 11, separately from the past sets of the address translation information and the management information.

Every time when at least one of the address translation information and the management information is updated, the SSD controller 7 may store the at least one of the address translation information and the management information after the update in the first storage unit 11, or for every predetermined period, may store the newest address translation information and management information stored in the fifth storage unit 15, in the first storage unit 11.

For each of the fourth storage unit 14 and the fifth storage unit 15, for example, an SRAM (Static Random Access Memory) or a DRAM (Dynamic Random Access Memory) is used. Although the SRAM can perform higher-speed read and write than the NAND memory, it tends to suffer more transient errors caused by radioactive rays such as cosmic rays. While the SSD controller 7 updates the address translation information and the management information stored in the fifth storage unit 15, as needed, duplicate information of the updated address translation information and management information is caused to be exhibited in the first storage unit 11 of the NAND memory chip 6. Moreover, when determining that a transient error occurs in the firmware stored in the fourth storage unit 14, the SSD controller 7 first resets the power supply of the SSD 5. When the firmware cannot recover yet from the error state, the SSD 5 is initialized to save the firmware stored in the third storage unit 13 of the NAND memory chip 6 in the fourth storage unit 14, and by executing the firmware stored in the fourth storage unit 14, the influence of the transient error is prevented.

The SSD controller 7 determines whether or not a transient error caused by radioactive rays such as cosmic rays occurs, based on communication with the host apparatus 3. When normally operating, the host apparatus 3 makes an access request to the SSD 5 immediately before, and then makes an access request within a predetermined period. Therefore, based on whether or not the host apparatus 3 makes an access request to the SSD 5 within the predetermined period, the SSD controller 7 can determine whether or not a transient error caused by radioactive rays occurs in the SSD controller 7.

The power supply management chip 4 resets or initializes the power supply of the SSD 5 in accordance with an instruction from the host apparatus 3. When it is determined that a transient error caused by radioactive rays such as cosmic rays occurs, the SSD controller 7 causes the duplicate information stored in the second storage unit 12 to be exhibited in the first storage unit 11. In initialization, the SSD controller 7 stores, in the fourth storage unit 14, and executes the firmware stored in the third storage unit 13 of the NAND memory chip 6. In this stage, the address translation information and the management information stored in the first storage unit 11 of the NAND memory chip 6 are stored in the fifth storage unit 15 and referred to.

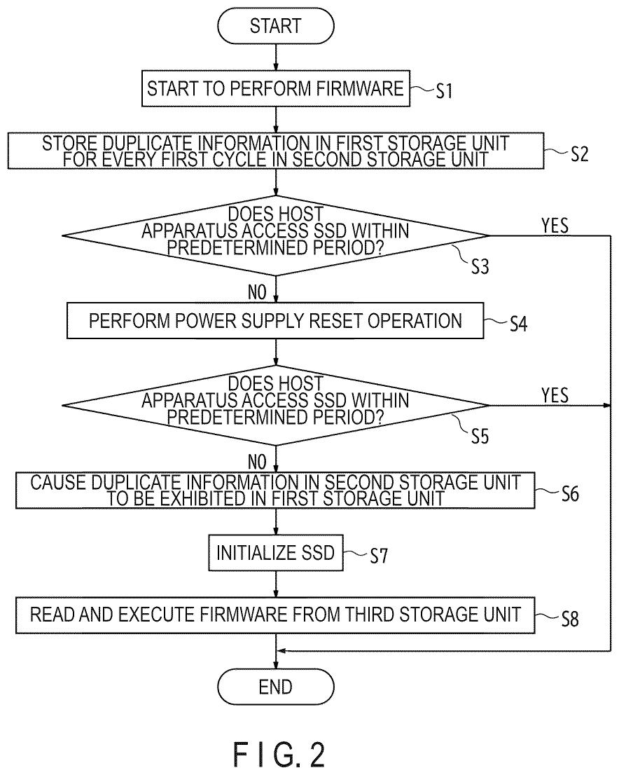

FIG. 2 is a flowchart showing processing operation of the memory system 1 according to the present embodiment. The flowchart in FIG. 2 is started after a power supply of the host apparatus 3 is turned on and initialization of the SSD 5 is finished.

The SSD controller 7 duplicates the firmware stored in the third storage unit 13 of the NAND memory chip 6 into the fourth storage unit 14, and in the state where the address translation information and the management information stored in the first storage unit 11 of the NAND memory chip 6 are duplicated in the fifth storage unit 15, reads and executes (or performs) the firmware from the fourth storage unit 14 (step S1).

After initialization processing of the SSD 5 is finished, the host apparatus 3 makes an access request for write or read of data to the SSD 5 in predetermined cycles. For example, in data write to the SSD 5, the host apparatus 3 issues a command, an address, and data. Since the address issued by the host apparatus 3 is a logical address, the SSD controller 7 translates the logical address into the physical address based on the aforementioned address translation information. Moreover, based on the management information, the SSD controller 7 determines, while preventing use of bad blocks, a place where the data from the host apparatus 3 is to be written. Notably, the cycles here can be changed in the middle of use of the SSD 5.

The SSD controller 7 performs verification of examining, after data is written in the memory block including a specific physical address of the NAND memory chip 6, whether or not the data has been correctly written. When the verification is not successful, the memory block in which the data write is performed is added as a bad block to the management information. In this case, the SSD controller 7 updates the management information in the first storage unit 11.

The SSD controller 7 stores duplicate information of the address translation information and the management information stored in the first storage unit 11 for every first cycle in the second storage unit 12 (step S2). Moreover, every time when at least one of the address translation information and the management information stored in the first storage unit 11 is updated, the SSD controller 7 stores the duplicate information of the updated address translation information and management information, in the second storage unit 12.

The SSD controller 7 determines whether or not the host apparatus 3 makes an access request to the SSD 5 within a predetermined period (step S3). While the time length of the predetermined period is optional, for example, the SSD controller 7 may determine whether or not the host apparatus 3 makes an access request to the SSD 5, for every second cycle that is not more than the time length of the first cycle.

In initialization of the SSD 5, the SSD controller 7 duplicates, into the fourth storage unit 14 of the SSD controller 7, and executes the firmware stored in the third storage unit 13 of the NAND memory chip 6. While the fourth storage unit 14 is constituted of an SRAM or a DRAM which can perform higher-speed read and write than the third storage unit 13 constituted of a NAND memory, it tends to suffer more transient errors caused by radioactive rays than the NAND memory. Since occurrence of a transient error causes bit flips, the SSD controller 7 cannot normally execute the firmware. Therefore, occurrence of transient errors caused by radioactive rays causes a concern that, even when the host apparatus 3 makes a certain access request to the SSD 5, the SSD 5 cannot respond to the access request. In this case, the host apparatus 3 resets and restarts the power supply of the SSD 5 using the power supply management chip 4, and after that, makes an access request to the SSD 5. While the SSD 5 has not yet recovered, the host apparatus 3 continues to wait for a response from the SSD 5, and hence, comes to not make an access request to the SSD 5 within the predetermined period. Therefore, step S3 mentioned above becomes NO, as shown in FIG. 2.

As above, in the present embodiment, it is supposed that, when a permanent error originating from a transient error occurs in the firmware, a response to the access request is not returned to the host apparatus 3 from the SSD 5, an access request is afterward no longer made to the SSD 5 from the host apparatus 3 within the predetermined period. Therefore, in step S3, when the host apparatus 3 does not make an access request to the SSD 5 within the predetermined period, it is determined that a permanent error originated from a transient error occurs in the firmware which is being executed by the SSD controller 7.

When step S3 is NO, as shown in FIG. 2, the SSD controller 7 determines that a transient error caused by radioactive rays occurs, and performs a power supply reset operation (step S4). In the power supply reset operation, since the power supply of the SSD 5 is first disconnected and turned on again, after the memory contents of the fourth storage unit 14 and the fifth storage unit 15 each constituted of an SRAM or a DRAM in the SSD controller 7 are erased, the address translation information and the management information stored in the first storage unit 11 are duplicated into the fifth storage unit 15, and the firmware stored in the third storage unit 13 is stored in the fourth storage unit 14.

Next, as implemented in step S3, it is determined whether or not the host apparatus 3 accesses the SSD 5 within the predetermined period after the power supply reset operation (step S5). When step S5 is YES, as shown in FIG. 2, it is determined that the transient error is solved, and the processing in FIG. 2 ends. When step S5 is NO, as shown in FIG. 2, the duplicate information stored in the second storage unit 12 is caused to be exhibited in the first storage unit 11 (step S6). Since when the transient error occurs in the firmware, there is concern that the first storage unit 11 is updated with inappropriate address translation information and management information, the address translation information and the management information that are present before the transient error occurs are caused to be exhibited in the first storage unit 11 from the second storage unit 12.

After the processing in step S6 is ended, the power supply management chip 4 initializes the SSD 5 (step S7). Thereby, the SSD controller 7 reads and executes the firmware stored in the third storage unit 13 of the NAND memory chip 6, and in this stage, refers to the address translation information and the management information stored in the first storage unit 11 (step S8). In more detail, the SSD controller 7 duplicates the firmware stored in the third storage unit 13 into the fourth storage unit 14, duplicates the address translation information and the management information stored in the first storage unit 11 into the fifth storage unit 15, reads and executes the firmware from the fourth storage unit 14, and in this stage, refers to the address translation information and the management information stored in the fifth storage unit 15.

When the processing in step S8 is finished, or when it is determined in step S3 or S5 that the host apparatus 3 makes an access request to the SSD 5 within the predetermined period, the processing of the flowchart in FIG. 2 ends. The processing of the flowchart in FIG. 2 is repeatedly performed in response to the power supply of the host apparatus 3 being turned on.

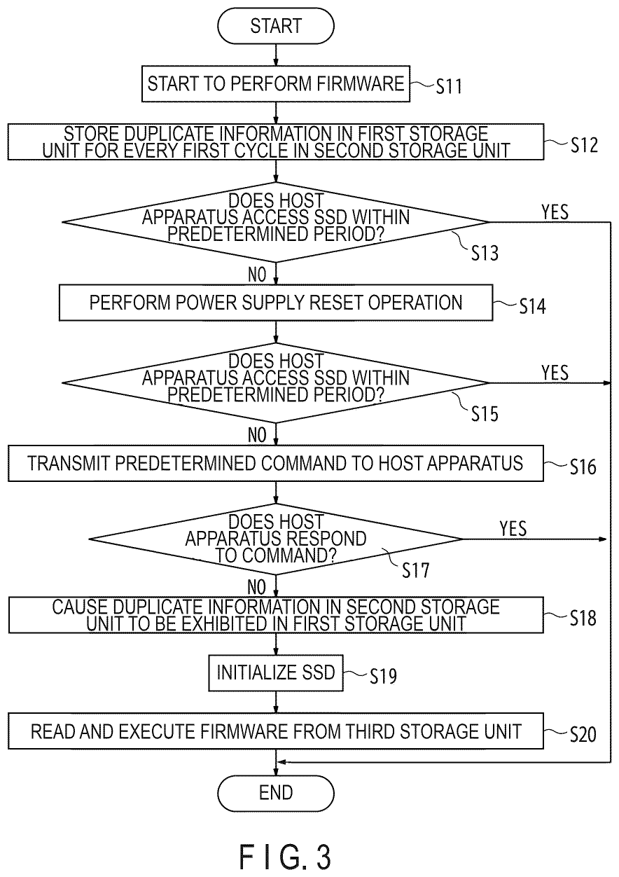

FIG. 3 is a flowchart showing processing operation of the memory system 1 according to a first modification of the present embodiment. In steps S11 to S15 in FIG. 3, the processing similar to that in steps S1 to S5 in FIG. 2 is performed. When NO is determined in step S15, the SSD controller 7 transmits a predetermined command to the host apparatus 3 (step S16).

The SSD controller 7 determines whether or not the host apparatus 3 responds to the command transmitted in step S16 (step S17). Steps S16 and S17 are performed for examining whether or not communication between the SSD controller 7 and the host apparatus 3 is correctly performed. When step S17 is NO, that is, when the host apparatus 3 does not respond, the processing similar to that in steps S6 to S8 is performed (steps S18 to S20).

When it is determined in step S13 or S15 that the host apparatus 3 makes an access request to the SSD 5 within the predetermined period or when it is determined in step S17 that the host apparatus 3 responds to the command, the processing of the flowchart in FIG. 3 end. The processing of the flowchart in FIG. 3 is repeatedly performed in response to the power supply of the host apparatus 3 being turned on.

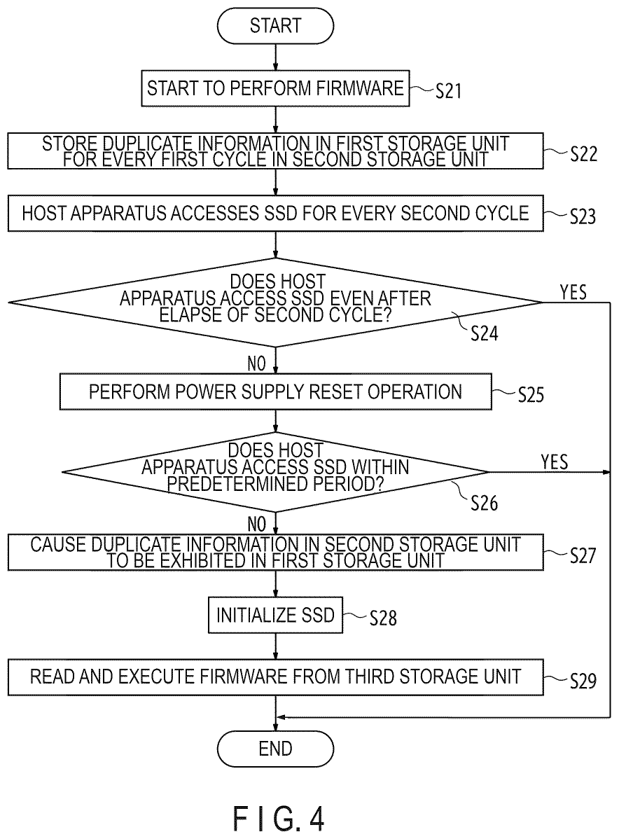

FIG. 4 is flowchart showing processing operation of the information processing system 2 according to a second modification of the present embodiment. In the information processing system 2 according to the second modification, after initialization of the SSD 5 is finished, the host apparatus 3 makes an access request to the SSD 5 for every second cycle.

In steps S21 and S22 in FIG. 4, the processing similar to that in steps S1 and S2 in FIG. 2 is performed. After initialization of the SSD 5 is finished, the host apparatus 3 repeatedly performs operation of making an access request to the SSD 5 for every second cycle (step S23).

The SSD controller 7 determines whether the host apparatus 3 does not access the SSD 5 even after the elapse of the second cycle (step S24). More specifically, in step S24, the determination is performed at a time length that is not less than the second cycle and less than the first cycle from the time point when the host apparatus 3 makes the access request as the start point. When NO is determined in step S24, the processing similar to that in steps S4 to S8 in FIG. 2 is performed (steps S25 to S29).

As above, on the premise that the host apparatus 3 makes access requests to the SSD 5 in the second cycles when the SSD controller 7 does not suffer a transient error, the SSD controller 7 determines whether or not there is an access request from the host apparatus 3, at a time length that is not less than the second cycle and less than the first cycle, and when it is determined that there is no access request, determines that a transient error caused by radioactive rays occurs.

When the processing in step S29 is finished, when it is determined that the host apparatus 3 makes an access request to the SSD 5 before the elapse of the second cycle in step S24, or when it is determined that the host apparatus 3 accesses the SSD 5 within the predetermined period in step S26, the processing of the flowchart in FIG. 4 ends. The processing of the flowchart in FIG. 4 is repeatedly performed in response to the power supply of the host apparatus 3 being turned on.

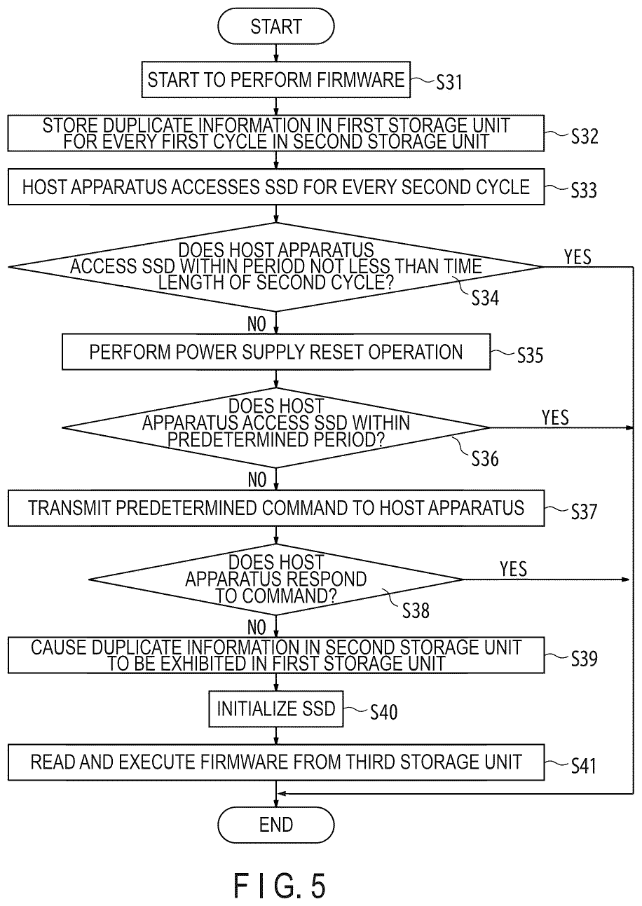

FIG. 5 is a flowchart showing processing operation of the information processing system 2 according to a third modification of the present embodiment. In steps S31 to S36 in FIG. 5, the processing similar to that in steps S21 to S26 in FIG. 4 is performed. When NO is determined in step S36, the SSD controller 7 transmits a predetermined command to the host apparatus 3 (step S37).

The SSD controller 7 determines whether or not the host apparatus 3 responds to the command transmitted in step S37 (step S38). When the host apparatus 3 does not respond, the processing similar to that in steps S4 to S6 is performed (steps S39 to S41).

As above, in the processing in FIG. 5, the SSD controller 7 determines whether or not there is an access request from the host apparatus 3, at a time length that is not less than the second cycle and less than the first cycle, transmits a predetermined command to the host apparatus 3 when it is determined that there is no access request, and determines that a permanent error originated from a transient error caused by radioactive rays occurs when there is no response to the predetermined command from the host apparatus 3.

When it is determined in step S34 that the host apparatus 3 makes the access request to the SSD 5 before the elapse of the second cycle, when it is determined in step S36 that the host apparatus 3 accesses the SSD 5 within the predetermined period, or when it is determined in step S38 that the host apparatus 3 responds to the command, the processing of the flowchart in FIG. 5 end. The processing of the flowchart in FIG. 5 is repeatedly performed in response to the power supply of the host apparatus 3 being turned on.

While for the information processing system 2 shown in FIG. 2 to FIG. 5, there has been shown the example in which the second storage unit 12 which the NAND memory chip 6 has stored duplicate information of one set of the address translation information and the management information, the second storage unit 12 may store a plurality of sets of the address translation information and the management information on a generation-by-generation basis. In this case, in initialization of the SSD 5, the duplicate information for the newest set stored in the second storage unit 12 is caused to be exhibited in the first storage unit 11 to restart the firmware, and when the SSD controller 7 comes to not yet operate normally, the duplicate information for the second newest set stored in the second storage unit 12 is overwritten in the first storage unit 11 to restart the firmware. Until the SSD controller 7 operates normally, the sets of the address translation information and the management information that are to be duplicated into the first storage unit 11 from the second storage unit 12 are sequentially switched.

Thereby, even when it is unclear at which time point the transient error occurs, the address translation information and the management information that are immediately before the occurrence of the transient error can be made to be exhibited in the first storage unit 11 so as to execute the firmware.

As above, in the present embodiment, when the host apparatus 3 does not make an access request to the SSD 5 within a predetermined period, the SSD controller 7 determines that a permanent error that originated from a transient error occurs, and causes the address translation information and the management information stored in the second storage unit 12 of the NAND memory chip 6 to be exhibited in the first storage unit 11 then to initialize the SSD 5. Thereby, the firmware stored in the third storage unit 13 of the NAND memory chip 6 is read and executed by the SSD controller 7. Therefore, even when bit flip occurs in the firmware stored in the fourth storage unit 14 of the SSD controller 7 due to the transient error, the firmware can be overwritten and reperformed, and the influence of the permanent error originated from the transient error can be prevented. Moreover, even when there is an error of a bit flip in the management information that is caused to be exhibited in the first storage unit 11 of the NAND memory chip 6 from the fifth storage unit 15 of the SSD controller 7, since before the error occurs, the duplicate information stored in the second storage unit 12 is duplicated into the fifth storage unit 15 via the first storage unit 11, and the influence of a permanent error originated from a transient error can also be prevented as to the management information.

According to the memory system 1 and the information processing system 2 according to the present embodiment, even when a transient error occurs in the SRAM or the DRAM built in or connected to the SSD controller 7, since the firmware can be read from the NAND memory chip 6 and executed after reset, a malfunction due to a transient error can be prevented. Therefore, the memory system 1 and the information processing system 2 according to the present embodiment can be used for artificial satellites in the low orbit zone where the rate of occurrence of transient errors is higher than on the ground. Therefore, costs for components of an artificial satellite can be reduced, and reliability of systems in the satellite can be improved.

### SUPPLEMENTS

### [Item 1]

A memory system including:
a nonvolatile memory chip; and
a controller that controls the nonvolatile memory chip, wherein
the controller
stores, in a first storage unit of the nonvolatile memory chip, address translation information for translating a logical address into a physical address and management information for the controller managing the nonvolatile memory chip,
for every first cycle, stores, in a second storage unit of the nonvolatile memory chip, duplicate information of the address translation information and the management information stored in the first storage unit, and
determines whether or not to cause the duplicate information stored in the second storage unit to be exhibited in the first storage unit.

### [Item 2]

The memory system of Item 1, wherein, when determining that a transient error caused by a radioactive ray occurs, the controller causes the duplicate information stored in the second storage unit to be exhibited in the first storage unit.

### [Item 3]

The memory system of Item 2, wherein the controller determines whether or not the transient error caused by the radioactive ray occurs, at a time length not less than a second cycle shorter than the first cycle.

### [Item 4]

The memory system of Item 3, wherein the controller determines whether or not the transient error caused by the radioactive ray occurs, at a time length that is not less than second cycle and shorter than the first cycle.

### [Item 5]

The memory system of Item 3 or 4, wherein the controller determines whether or not the transient error caused by the radioactive ray occurs, based on communication with a host apparatus.

### [Item 6]

The memory system of Item 5, wherein
when the transient error does not occur, the host apparatus makes an access request to the nonvolatile memory chip for every second cycle, and
the controller determines whether or not there is the access request from the host apparatus, at a time length not less than the second cycle, and when it is determined that there is no access request, determines that the transient error caused by the radioactive ray occurs.

### [Item 7]

The memory system of Item 6, wherein the controller determines whether or not there is the access request from the host apparatus at a length not less than the second cycle, transmits a predetermined command to the host apparatus when it is determined that there is no access request, and when there is no response to the predetermined command from the host apparatus, determines that the transient error caused by the radioactive ray occurs.

### [Item 8]

The memory system of any one of Items 5 to 7, wherein
the controller stores a plurality of times of the past duplicate information in the second storage unit, and
when there is no access request from the host apparatus, the controller predominantly reads and causes the duplicate information that is most newly stored in the second storage unit to be exhibited in the first storage unit.

### [Item 9]

The memory system of Item 8, wherein the controller sequentially reads the newer duplicate information in a temporal order in which the items of duplicate information are stored in second storage unit, and restarts firmware, until the access request from the host apparatus is received.

### [Item 10]

The memory system of any one of Items 1 to 9, wherein the controller stores duplicate information in the second storage unit every time when at least one of the address translation information and the management information stored in the first storage unit is updated.

### [Item 11]

The memory system of any one of Items 1 to 10, wherein, for every first cycle, the controller stores, in the second storage unit, duplicate information of the address translation information and the management information stored in the first storage unit and user data stored in the nonvolatile memory chip.

### [Item 12]

The memory system of Item 11, wherein the user data includes at least one of a program of an operation system, a program of application software operated on the operation system, data used for the operation system, and data used for the application software.

### [Item 13]

The memory system of any one of Items 1 to 12, wherein
the nonvolatile memory chip has a third storage unit in which firmware that controls the controller is stored, and
the controller reads and executes the firmware stored in the third storage unit, in initialization or reset of the nonvolatile memory chip.

### [Item 14]

The memory system of Item 13, wherein, when reading the firmware stored in the third storage unit, the controller reads the address translation information and the management information stored in the first storage unit to execute the firmware.

### [Item 15]

The memory system of Item 13 or 14, wherein the nonvolatile memory chip is reset after the duplicate information stored in the second storage unit is caused to be exhibited in the first storage unit.

### [Item 16]

The memory system of any one of Items 13 to 15, wherein
the controller has
a fourth storage unit that stores the firmware read from the third storage unit, and
a fifth storage unit that stores the address translation information and the management information read from the first storage unit, and
the fourth storage unit and the fifth storage unit have a higher probability of a transient error caused by a radioactive ray than the nonvolatile memory chip.

### [Item 17]

The memory system of Item 16, wherein
each of the fourth storage unit and the fifth storage unit is an SRAM (Static Random Access Memory) or a DRAM (Dynamic Random Access Memory), and
the nonvolatile memory chip is a flash memory.

### [Item 18]

The memory system of Item 16 or 17, wherein, when determining that the transient error caused by the radioactive ray occurs, the controller performs power supply reset operation of erasing memory contents of the fourth storage unit and the fifth storage unit, determines whether or not the transient error is solved afterward, and when determining that the transient error is not solved, causes the duplicate information stored in the second storage unit to be exhibited in the first storage unit.

### [Item 19]

The memory system of any one of Items 1 to 18, wherein, when at least one of the address translation information and the management information is updated, the controller stores the updated at least one of the address translation information and the management information in the first storage unit.

### [Item 20]

An information processing system including:
a memory system; and
a host apparatus connected to the memory system, wherein
the memory system has
a nonvolatile memory chip, and
a controller that controls the nonvolatile memory chip,
the controller
stores, in a first storage unit of the nonvolatile memory chip, address translation information for translating a logical address into a physical address and management information for the controller managing the nonvolatile memory chip,
for every first cycle, stores, in a second storage unit of the nonvolatile memory chip, duplicate information of the address translation information and the management information stored in the first storage unit, and
determines whether or not to cause the duplicate information stored in the second storage unit to be exhibited in the first storage unit.

### [Item 21]

The information processing system of Item 20, including
a power supply management apparatus that performs control of initializing the memory system, wherein
the host apparatus instructs the power supply management apparatus to initialize the memory system when it is determined that a transient error caused by a radioactive ray occurs,
the nonvolatile memory chip has a third storage unit that stores firmware that controls the controller, and
when the nonvolatile memory chip is initialized with control of the power supply management apparatus, the controller reads and executes the firmware stored in the third storage unit after the duplicate information stored in the second storage unit is caused to be exhibited in the first storage unit.

### [Item 22]

The information processing system of Item 20 or 21, wherein the memory system is arranged in a low orbit zone.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A memory system comprising:
a nonvolatile memory chip; and
a controller that controls the nonvolatile memory chip, wherein
the controller is configured to
store, in a first storage unit of the nonvolatile memory chip, address translation information for translating a logical address into a physical address and management information for the controller to use in management of operations of the nonvolatile memory chip,
for every first cycle, store, in a second storage unit of the nonvolatile memory chip, duplicate information of the address translation information and the management information stored in the first storage unit, and
determine whether to cause the duplicate information stored in the second storage unit to be exhibited in the first storage unit.

2. The memory system of claim 1, wherein, in response to a determination by the controller that a transient error caused by a radioactive ray has occurred, the controller is further configured to cause the duplicate information stored in the second storage unit to be exhibited in the first storage unit.

3. The memory system of claim 2, wherein the controller is further configured to determine whether the transient error caused by the radioactive ray occurs at a time length not less than a second cycle that is shorter than the first cycle.

4. The memory system of claim 3, wherein the controller is further configured to determine whether the transient error caused by the radioactive ray occurs at the time length that is not less than the second cycle and also shorter than the first cycle.

5. The memory system of claim 2, wherein the controller is further configured to determine whether the transient error caused by the radioactive ray occurs based on communication with a host apparatus.

6. The memory system of claim 5, wherein
under a condition the transient error does not occur, and the host apparatus makes an access request to the nonvolatile memory chip for every second cycle, the controller is further configured to determine whether there is the access request from the host apparatus, at a time length not less than the second cycle, and in response to a determination that there is no access request, determine that the transient error caused by the radioactive ray has occurred.

7. The memory system of claim 6, wherein the controller is further configured to determine whether there is the access request from the host apparatus at a length not less than the second cycle and transmit a predetermined command to the host upon apparatus determination that there is no access request, and when there is no response to the predetermined command from the host apparatus, determine that the transient error caused by the radioactive ray has occurred.

8. The memory system of claim 5, wherein
the controller is configured to store a plurality of times the past duplicate information in the second storage unit, and
under a condition there is no access request from the host apparatus, the controller is further configured to read and cause the duplicate information that is most newly stored in the second storage unit to be exhibited in the first storage unit.

9. The memory system of claim 8, wherein the controller is further configured to sequentially read the most newly stored duplicate information in a temporal order in which the items of duplicate information are stored in the second storage unit, and restart firmware, until the access request from the host apparatus is received.

10. The memory system of claim 1, wherein the controller is further configured to store the duplicate information in the second storage unit every time at least one of the address translation information and the management information stored in the first storage unit is updated.

11. The memory system of claim 1, wherein, for every first cycle, the controller is further configured to store, in the second storage unit, duplicate information of the address translation information and the management information stored in the first storage unit and user data stored in the nonvolatile memory chip.

12. The memory system of claim 11, wherein the user data includes at least one of program code of an operation system, program code of application software operated on the operation system, data used for the operation system, and data used for the application software.

13. The memory system of claim 1, wherein
the nonvolatile memory chip has a third storage unit in which firmware that controls the controller is stored, and
the controller is further configured to read and execute the firmware stored in the third storage unit, as part of initialization or reset of the nonvolatile memory chip.

14. The memory system of claim 13, wherein, when reading the firmware stored in the third storage unit, the controller is further configured to read the address translation information and the management information stored in the first storage unit to execute the firmware.

15. The memory system of claim 13, wherein the controller is further configured to reset the nonvolatile memory chip after the duplicate information stored in the second storage unit is caused to be exhibited in the first storage unit.

16. The memory system of claim 13, wherein
the controller further includes
a fourth storage unit that stores the firmware that is read from the third storage unit, and
a fifth storage unit that stores the address translation information and the management information read from the first storage unit, and
circuitry structures of the fourth storage unit and the fifth storage unit exhibit a higher susceptibility to a transient error caused by a radioactive ray than a structure of the nonvolatile memory chip.

17. The memory system of claim 16, wherein
each of the fourth storage unit and the fifth storage unit is an SRAM (Static Random Access Memory) or a DRAM (Dynamic Random Access Memory), and
the nonvolatile memory chip is a flash memory.

18. The memory system of claim 16, wherein, when determining that the transient error caused by the radioactive ray occurs, the controller is further configured to perform a power supply reset operation that erases memory contents of the fourth storage unit and the fifth storage unit, determine whether the transient error is solved afterward, and upon a determination that the transient error is not solved, cause the duplicate information stored in the second storage unit to be exhibited in the first storage unit.

19. The memory system of claim 1, wherein, when at least one of the address translation information and the management information is updated, the controller is further configured to store at least one of updated address translation information and updated management information in the first storage unit.

20. An information processing system comprising:
a memory system; and
a host apparatus connected to the memory system, wherein
the memory system has
a nonvolatile memory chip, and
a controller that controls the nonvolatile memory chip,
the controller is configured to
store, in a first storage unit of the nonvolatile memory chip, address translation information for translating a logical address into a physical address and management information for the controller to use in management of operations of the nonvolatile memory chip,
for every first cycle, store, in a second storage unit of the nonvolatile memory chip, duplicate information of the address translation information and the management information stored in the first storage unit, and
determine whether to cause the duplicate information stored in the second storage unit to be exhibited in the first storage unit.

21. The information processing system of claim 20, comprising
a power supply management apparatus having circuitry configured to control initialization of the memory system, wherein
the host apparatus is configured to instruct the power supply management apparatus to initialize the memory system under a condition the controller determines a transient error caused by a radioactive ray has occurred,
the nonvolatile memory chip has a third storage unit that stores firmware that upon execution by the controller configures the controller to perform control operations, and
in response to the nonvolatile memory chip being initialized via control of the power supply management apparatus, the controller is further configured to read and execute the firmware stored in the third storage unit after the duplicate information stored in the second storage unit is caused to be exhibited in the first storage unit.

22. The information processing system of claim 20, wherein the memory system is arranged in a low orbit zone.
